(19) United States
(12) Patent Application Publication
(10) Pub. No.: US 2024/0081408 A1
(43) Pub. Date: Mar. 14, 2024

(54) AEROSOL GENERATION SYSTEM

(71) Applicant: JAPAN TOBACCO INC., Tokyo (JP)

(72) Inventors: Manabu YAMADA, Tokyo (JP); Yasunobu INOUE, Tokyo (JP)

(73) Assignee: JAPAN TOBACCO INC., Tokyo (JP)

(21) Appl. No.: 18/518,224

(22) Filed: Nov. 22, 2023

Related U.S. Application Data
(63) Continuation of application No. PCT/JP2021/027410, filed on Jul. 21, 2021.

(51) Int. Cl. A24F 40/46; H05B 3/02

(52) U.S. Cl. CPC A24F 40/46; H05B 3/02

(57) ABSTRACT

An aerosol generation system that generates aerosol by heating an aerosol generation product containing an aerosol source, and comprises: an accommodation part that has an internal space and an opening through which the internal space communicates with the outside, and that accommodates the aerosol generation product inserted into the internal space though the opening; a first electrically-insulating part, which is an electrically-insulating film-like member disposed outward of the accommodation part; an electrical resistance part that is disposed outward of the first electrically-insulating part and generates heat when energized; and a heat radiation suppressing part that is disposed further outward than the electrical resistance part and suppresses heat radiation.

### CROSS REFERENCES TO RELATED APPLICATIONS

This application is a continuation application based on International Patent Application No. PCT/JP2021/027410 filed on Jul. 21, 2021, and the content of the PCT international application is incorporated herein by reference.

### TECHNICAL FIELD

The present invention relates to an aerosol generation system.

### BACKGROUND ART

Inhaler devices such as electronic cigarettes and nebulizers that generate a material to be inhaled by a user have become widely popular. For example, an inhaler device generates an aerosol to which a flavor component has been imparted by using a substrate including an aerosol source for generating an aerosol and a flavor source for imparting a flavor component to the generated aerosol. A user can taste flavor by inhaling the aerosol to which the flavor component has been imparted thus generated by the inhaler device. A user's aerosol inhaling action is hereinafter also referred to as a puff or a puff action.

In recent years, various techniques for efficiently generating an aerosol have been developed. For example, Patent Literature 1 below discloses a technique of increasing heating efficiency by setting thermal emissivity of an outer surface of a heating element that is induction-heated by intrusion of a varying magnetic field to 0.05 or less in an induction heating type inhaler device.

### CITATION LIST

### Patent Literature

Patent Literature 1: JP 2018-529324 A

### SUMMARY OF INVENTION

### Technical Problem

However, it has not been long since the technique disclosed in Patent Literature 1 was developed, and there are rooms for improvement in various aspects.

The present invention was accomplished in view of the above problem, and an object of the present invention is to provide a mechanism that can improve heating efficiency of an inhaler device.

### Solution to Problem

In order to solve the above problem, according to an aspect of the present invention, provided is an aerosol generation system that generates an aerosol by heating an aerosol generation article that contains an aerosol source, including a container that has an internal space and an opening that allows the internal space to communicate with an outside and accommodates the aerosol generation article inserted into the internal space through the opening; a first electrical insulation part that is a film-shaped member having an electrical insulation property and is disposed outside the container; an electrical resistance part that is disposed outside the first electrical insulation part and produces heat in a case where an electric current passes therethrough; and a heat radiation suppressor that is disposed outside the electrical resistance part and suppresses heat radiation.

The aerosol generation system may include, as the heat radiation suppressor, a second electrical insulation part that is a film-shaped member having an electrical insulation property that is disposed outside the electrical resistance part and suppresses heat radiation, and the electrical resistance part may be sandwiched between the first electrical insulation part and the second electrical insulation part.

The second electrical insulation part may be formed by applying varnish containing a material having an electrical insulation property and a material having a property of suppressing heat radiation.

The aerosol generation system may further include a second electrical insulation part that is a film-shaped member having an electrical insulation property and is disposed outside the electrical resistance part, the electrical resistance part may be sandwiched between the first electrical insulation part and the second electrical insulation part, and the heat radiation suppressor may be disposed outside the second electrical insulation part.

The heat radiation suppressor may be formed by applying varnish containing a material having a property of suppressing heat radiation.

The first electrical insulation part and the second electrical insulation part may be made of one or more materials selected from the group consisting of polyimide, PEEK, polyurethane, epoxy, polyester, acrylic, phenol, and silicone as a material having an electrical insulation property.

The heat radiation suppressor may be made of one or more materials selected from the group consisting of SiC, TiO₂, alumina, yttria, a metal oxide, and a composite metal containing a plurality of metal atoms and a plurality of oxygen atoms as a material that has a property of suppressing heat radiation.

The first electrical insulation part, the electrical resistance part, and the heat radiation suppressor may be fixed to the container by a heat shrinkable tube.

The aerosol generation system may further include a second electrical insulation part that is a film-shaped member having an electrical insulation property that is disposed outside the electrical resistance part; and a clip including a first panel that is the heat radiation suppressor configured as a planar member, a second panel that is the heat radiation suppressor configured as a planar member, and a coupling part that is an elastic body that couples the first panel and the second panel, and the clip may hold the container between the first panel and the second panel from an outer side of the second electrical insulation part.

The aerosol generation system may further include a clip including a first panel that is the heat radiation suppressor configured as a planar member and has an electrical insulation property, a second panel that is the heat radiation suppressor configured as a planar member and has an electrical insulation property, and a coupling part that is an elastic body that couples the first panel and the second panel, and the clip may hold the container between the first panel and the second panel from an outer side of the electrical resistance part.

The first panel and the second panel may have a shape along a shape of a side wall of the container.

The container may have two flat side walls that face each other, the first panel and the second panel may each have a flat surface, the coupling part may couple the flat surface of the first panel and the flat surface of the second panel, and the clip may hold the container in a state where the flat surface of the first panel and the flat surface of the second panel are positioned to fit the two flat side walls of the container.

The aerosol generation system may further include the aerosol generation article.

### Advantageous Effects of Invention

As described above, according to the present invention, a mechanism that can improve heating efficiency of an inhaler device is provided.

### BRIEF DESCRIPTION OF DRAWINGS

FIG. 1 is a schematic diagram schematically illustrating a configuration example of an inhaler device.

FIG. 2 is a cross-sectional view schematically illustrating a cross-section around a holder of an inhaler device according to a first embodiment.

FIG. 3 is a cross-sectional view schematically illustrating a cross-section around a holder of an inhaler device according to a second embodiment.

FIG. 4 is a perspective view of a configuration around a holder of an inhaler device according to a third embodiment.

FIG. 5 is a cross-sectional view schematically illustrating a cross-section around the holder of the inhaler device according to the third embodiment.

FIG. 6 is a cross-sectional view schematically illustrating a cross-section around a holder of an inhaler device according to a fourth embodiment.

FIG. 7 is a perspective view of a configuration around a holder of an inhaler device according to a modification.

### DESCRIPTION OF EMBODIMENTS

Preferred embodiments of the present invention are described in detail below with reference to the attached drawings. Note that in the specification and drawings, structural elements having substantially identical functional configurations are given identical reference signs, and repeated description thereof is omitted. 1. Configuration Example of Inhaler Device

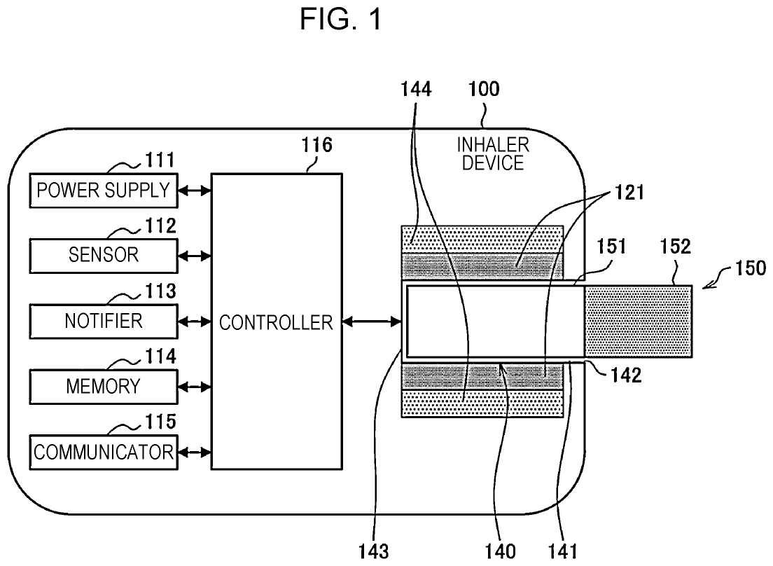

An inhaler device according to the present configuration example generates an aerosol by heating a substrate including an aerosol source from an outside of the substrate. The present configuration example is described below with reference to FIG. 1.

FIG. 1 is a schematic diagram schematically illustrating a configuration example of an inhaler device. As illustrated in FIG. 1, an inhaler device 100 according to the present configuration example includes a power supply 111, a sensor 112, a notifier 113, a memory 114, a communicator 115, a controller 116, a heater 121, a holder 140, and a heat insulator 144. User's inhalation is performed while a stick substrate 150 is being held by the holder 140. The structural elements are described below in order.

The power supply 111 stores electric power. The power supply 111 supplies electric power to each structural element of the inhaler device 100. The power supply 111 can be, for example, a rechargeable battery such as a lithium ion secondary battery. The power supply 111 may be charged by being connected to an external power supply by a universal serial bus (USB) cable or the like. The power supply 111 may be charged without being connected to a power transmission side device by a wireless power transmission technology. Alternatively, only the power supply 111 may be detachable from the inhaler device 100 and replaceable with a new power supply 111.

The sensor 112 detects various kinds of information concerning the inhaler device 100. Then, the sensor 112 outputs the detected information to the controller 116. In one example, the sensor 112 is a pressure sensor such as a capacitor microphone, a flow sensor, or a temperature sensor. In a case where the sensor 112 detects a numerical value associated with user's inhalation, the sensor 112 outputs information indicating that user's inhalation has been performed to the controller 116. In another example, the sensor 112 is an input device, such as a button or a switch, that receives user's input of information. In particular, the sensor 112 can include a button for starting/stopping generation of an aerosol. The sensor 112 outputs information input by the user to the controller 116. In another example, the sensor 112 is a temperature sensor that detects a temperature of the heater 121. The temperature sensor detects a temperature of the heater 121, for example, on the basis of an electric resistance value of a conductive track of the heater 1121. The sensor 112 may detect a temperature of the stick substrate 150 held by the holder 140 on the basis of the temperature of the heater 121.

The notifier 113 notifies the user of information. In an example, the notifier 113 is a light-emitting device such as a light emitting diode (LED). In this case, the notifier 113 emits light in different patterns of light, for example, in a case where the power supply 111 needs to be charged, a case where the power supply 111 is being charged, and a case where an abnormality has occurred in the inhaler device 100. The pattern of light is a concept including a color, a timing of ON/OFF, and the like. The notifier 113 may be a display device that displays an image, a sound output device that outputs sound, a vibration device that vibrates, or the like together with or instead of the light-emitting device. In addition, the notifier 113 may notify the user of information indicating that the user has become able to inhale. The information indicating that the user has become able to inhale is provided in a case where the temperature of the stick substrate 150 heated by the heater 121 has reached a predetermined temperature.

The memory 114 stores various items of information for operation of the inhaler device 100. The memory 114 is, for example, a non-volatile storage medium such as a flash memory. An example of the information stored in the memory 114 is information concerning an Operating System (OS) of the inhaler device 100 such as contents of control of the structural elements by the controller 116. Another example of the information stored in the memory 114 is information regarding user's inhalation such as the number of times of inhalation, an inhalation time, and an accumulated inhalation time period.

The communicator 115 is a communication interface for transmitting and receiving information between the inhaler device 100 and another device. The communicator 115 performs communication in conformity with any wired or wireless communication standard. Such a communication standard may be, for example, a wireless local area network (LAN), a wired LAN, Wi-Fi (registered trademark), or Bluetooth (registered trademark). In an example, the communicator 115 transmits information regarding user's inhalation to a smartphone to display the information regarding user's inhalation on the smartphone. In another example, the communicator 115 receives information regarding a new OS from a server to update information of the OS stored in the memory 114.

The controller 116 functions as an arithmetic processing unit and a control device, and controls the overall operations of the inhaler device 100 in accordance with various programs. The controller 116 includes an electronic circuit such as a central processing unit (CPU) or a microprocessor, for example. In addition, the controller 116 may include a read only memory (ROM) that stores programs and operation parameters to be used and a random access memory (RAM) that temporarily stores parameters that change as appropriate. The inhaler device 100 performs various kinds of processing under control of the controller 116. Supply of electric power from the power supply 111 to the other structural elements, charging of the power supply 111, detection of information by the sensor 112, notification of information by the notifier 113, storing and reading out of information by the memory 114, and transmission and reception of information by the communicator 115 are examples of processing controlled by the controller 116. Other processing performed by the inhaler device 100 such as input of information to the structural elements and processing based on information output from the structural elements is also controlled by the controller 116.

The holder 140 has an internal space 141 and holds the stick substrate 150 in a manner partially accommodated in the internal space 141. The holder 140 has an opening 142 that allows the internal space 141 to communicate with outside. The holder 140 holds the stick substrate 150 that is inserted into the internal space 141 through the opening 142. For example, the holder 140 is a tubular body having the opening 142 and a bottom 143 as a bottom surface, and defines the pillar-shaped internal space 141. The holder 140 is configured such that an inside diameter thereof is smaller than an outside diameter of the stick substrate 150 at least at a part in a height direction of the tubular body, and can hold the stick substrate 150 in a manner such that the stick substrate 150 inserted into the internal space 141 is pressed from an outer circumference. The holder 140 also defines a flow path of air passing through the stick substrate 150. For example, the bottom 143 has an air inlet hole that is an inlet of air into the flow path. The opening 142 serves as an air outlet hole that is an outlet of the air from the flow path.

The stick substrate 150 is a stick-shaped member. The stick substrate 150 includes a substrate 151 and an inhalation port 152.

The substrate 151 includes an aerosol source. The aerosol source is atomized by heating, and thus the aerosol is generated. The aerosol source may be, for example, one derived from tobacco such as shredded tobacco or a tobacco raw material processed in a granular shape, a sheet shape, or a powder shape. Furthermore, the aerosol source may include one not derived from tobacco created from a plant (e.g., mint or a herb) other than tobacco. In an example, the aerosol source may include a flavor component such as menthol. In a case where the inhaler device 100 is a medical inhaler, the aerosol source may include a medicine to be inhaled by a patient. Note that the aerosol source is not limited to a solid and may be, for example, a liquid such as polyhydric alcohol or water. Examples of the polyhydric alcohol include glycerine and propylene glycol. At least a part of the substrate 151 is accommodated in the internal space 141 of the holder 140 in a state where the stick substrate 150 is held by the holder 140.

The inhalation port 152 is a member held in a user's mouth during inhalation. At least a part of the inhalation port 152 protrudes from the opening 142 in a state where the stick substrate 150 is held by the holder 140. When the user inhales with the inhalation port 152 protruding from the opening 142 in his/her mouth, air flows into the holder 140 through the air inlet hole (not illustrated). The air passes through the internal space 141 of the holder 140, that is, passes through the substrate 151, and the air and an aerosol generated from the substrate 151 reach inside the mouth of the user.

The heater 121 heats the aerosol source to atomize the aerosol source and thus generate the aerosol. The heater 121 is made of any material such as a metal or polyimide. For example, the heater 121 has a film-like shape and surrounds the outer circumference of the holder 140. Heat produced from the heater 121 heats and atomizes the aerosol source included in the stick substrate 150 from the outer circumference of the stick substrate 150, generating the aerosol. The heater 121 produces heat when receiving electric power from the power supply 111. In an example, the electric power may be supplied in response to the sensor 112 detecting a predetermined user's input. The user becomes able to inhale in a case where the temperature of the stick substrate 150 heated by the heater 121 has reached a predetermined temperature. Subsequently, the supply of the electric power may be stopped in response to the sensor 112 detecting a predetermined user's input. In another example, the electric power may be supplied and the aerosol may be generated while the sensor 112 is detecting user's inhalation.

The heat insulator 144 prevents heat from transferring from the heater 121 to the other structural elements of the inhaler device 100. The heat insulator 144 is disposed so as to cover at least an outer circumference of the heater 121. For example, the heat insulator 144 is a vacuum heat insulator, an aerogel heat insulator, or the like. Note that the vacuum heat insulator is, for example, a heat insulator that makes heat conduction by gas as close to zero as possible by wrapping glass wool, silica (silicon powder), or the like with a film made of a resin and thus creating a high-vacuum state.

The stick substrate 150 is an example of an aerosol generation article containing an aerosol source. The holder 140 is an example of a container that accommodates the stick substrate 150 inserted into the internal space 141. The inhaler device 100 and the stick substrate 150 generate an aerosol to be inhaled by a user in cooperation with each other. Accordingly, a combination of the inhaler device 100 and the stick substrate 150 may be grasped as an aerosol generation system.

### 2. First Embodiment

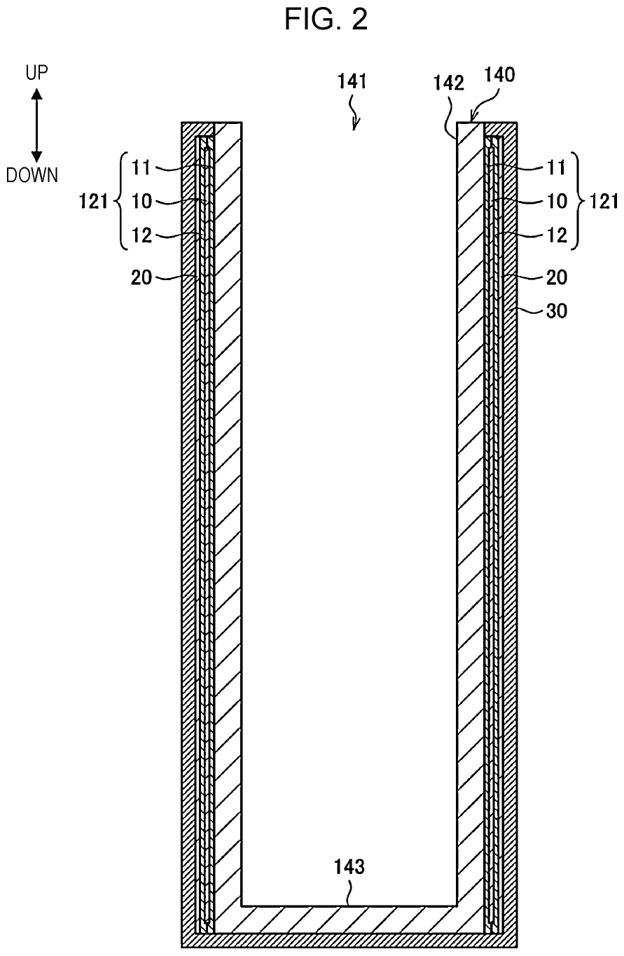

FIG. 2 is a cross-sectional view schematically illustrating a cross section around a holder 140 of an inhaler device 100 according to the present embodiment. As illustrated in FIG. 2, a heater 121, a heat radiation suppressor 20, and a heat shrinkable tube 30 are disposed on a side surface of the holder 140.

In the following description, a direction in which a stick substrate 150 is inserted into an internal space 141 is also referred to as a downward direction. On the other hand, a direction in which the stick substrate 150 is removed from the internal space 141 is also referred to as an upward direction. In a space outside the holder 140, a side closer to the holder 140 is also referred to as an inside, and a side far from the holder 140 is also referred to as an outside.

As illustrated in FIG. 2, the heater 121 is disposed outside the holder 140. The holder 140 is made of a material that has a predetermined heat-transfer property such as Steel Use Stainless (SUS). Accordingly, heat emitted by the heater 121 can heat the stick substrate 150 accommodated in the internal space 141 of the holder 140 through the holder 140.

As illustrated in FIG. 2, the heater 121 includes an electrical resistance part 10, a first electrical insulation part 11, and a second electrical insulation part 12.

The electrical resistance part 10 is a member that produces heat when an electric current passes therethrough. More specifically, the electrical resistance part 10 emits Joule heat when an electric current passes therethrough. The electrical resistance part 10 is, for example, made of Steel Use Stainless (SUS). In this case, the electrical resistance part 10 can exhibit high heat resistance.

In an example, the electrical resistance part 10 may be a conductive track. The conductive track is stretched around the holder 140 while being bent. The side surface of the holder 140 can be heated in any heat distribution according to a distribution of the conductive track around the holder 140.

The first electrical insulation part 11 and the second electrical insulation part 12 are film-shaped members having an electrical insulation property. The first electrical insulation part 11 is disposed outside the holder 140 and inside the electrical resistance part 10. The second electrical insulation part 12 is disposed outside the electrical resistance part 10. That is, the electrical resistance part 10 is disposed outside the first electrical insulation part 11 and inside the second electrical insulation part 12. The first electrical insulation part 11 and the second electrical insulation part 12 sandwich the electrical resistance part 10. According to this configuration, the electrical resistance part 10 is prevented from making contact with and being short-circuited with another electrical conductor.

The first electrical insulation part 11 and the second electrical insulation part 12 are made of any material having an electrical insulation property. For example, the first electrical insulation part 11 and the second electrical insulation part 12 may be made of one or more materials selected from the group consisting of polyimide, poly ether ether ketone (PEEK), polyurethane, epoxy, polyester, acrylic, phenol, and silicone as the material having an electrical insulation property. The first electrical insulation part 11 and the second electrical insulation part 12 may be formed by applying varnish containing a material having an electrical insulation property. In a case where varnish application is employed, the first electrical insulation part 11 and the second electrical insulation part 12 can be easily positioned as compared with a case where a film that is separately formed is disposed.

As illustrated in FIG. 2, the heat radiation suppressor 20 is disposed outside the second electrical insulation part 12. That is, the heat radiation suppressor 20 is disposed outside the electrical resistance part 10. The heat radiation suppressor 20 is a member that has a property of suppressing heat radiation (i.e., heat emission). In an example, the heat radiation suppressor 20 is configured such that a heat radiation rate (i.e., thermal emissivity) becomes 0.7 or less.

According to this configuration, thermal loss caused by heat radiation from the electrical resistance part 10 to an outside can be suppressed. The holder 140 and the stick substrate 150 accommodated in the holder 140 that are disposed on a side opposite to a side where the heat radiation suppressor 20 is disposed, that is, on an inner side relative to the electrical resistance part 10 can be efficiently heated. Since heat radiation to an outside of the heat radiation suppressor 20 is suppressed, a rise in temperature of other structural elements such as the controller 116 and a housing of the inhaler device 100 that are disposed outside the heat radiation suppressor 20 can be prevented. This can improve stability of operation of the inhaler device 100 and improve user's safety.

The heat radiation suppressor 20 is made of any material that has a property of suppressing heat radiation. For example, the heat radiation suppressor 20 may be made of one or more materials selected from the group consisting of SiC, TiO₂, alumina, yttria, a metal oxide, and a composite metal containing a plurality of metal atoms and a plurality of oxygen atoms as the material that has a property of suppressing heat radiation. The heat radiation suppressor 20 may be formed by applying varnish containing a material that has a property of suppressing heat radiation. In a case where application of varnish is employed, the heat radiation suppressor 20 can be easily positioned as compared with a case where the heat radiation suppressor 20 that is separately formed is disposed.

The first electrical insulation part 11, the electrical resistance part 10, the second electrical insulation part 12, and the heat radiation suppressor 20 are fixed to the holder 140 by the heat shrinkable tube 30. The heat shrinkable tube 30 is a tubular member that shrinks upon application of heat. For example, the heat shrinkable tube 30 is made of a resin material. By heating the heat shrinkable tube 30 in a state where the first electrical insulation part 11, the electrical resistance part 10, the second electrical insulation part 12, the heat radiation suppressor 20, and the heat shrinkable tube 30 are laminated in order on the holder 140, these structural elements can be easily fixed.

As described above, according to the present embodiment, the heat radiation suppressor is disposed outside the heater 121, and therefore heating efficiency of the stick substrate 150 can be improved.

### 3. Second Embodiment

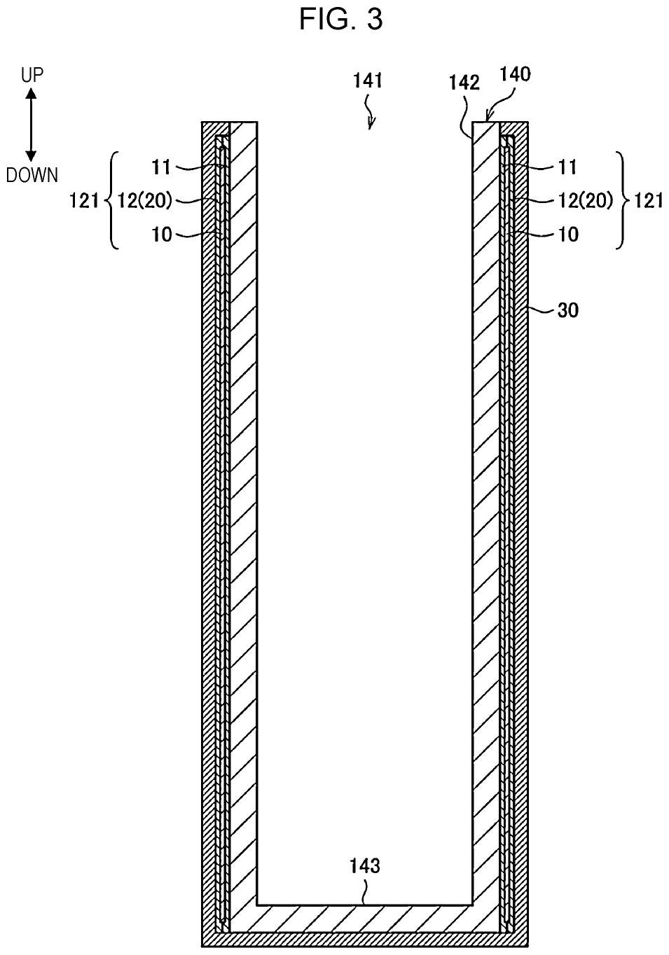

FIG. 3 is a cross-sectional view schematically illustrating a cross section around a holder 140 of an inhaler device 100 according to the present embodiment. As illustrated in FIG. 3, a heater 121 and a heat shrinkable tube 30 are disposed on a side surface of the holder 140.

The inhaler device 100 according to the present embodiment is different from the first embodiment in that a second electrical insulation part 12 also functions as a heat radiation suppressor 20. The following mainly describes differences from the first embodiment, and description of points similar to those in the first embodiment is omitted.

The second electrical insulation part 12 according to the present embodiment also functions as the heat radiation suppressor 20 that suppresses heat radiation. That is, the second electrical insulation part 12 is a film-shaped member that has an electrical insulation property and suppresses heat radiation.

The second electrical insulation part 12 is made of both of any material having an electrical insulation property and any material that has a property of suppressing heat radiation. For example, the second electrical insulation part 12 may be formed by applying varnish containing a material having an electrical insulation property and a material that has a property of suppressing heat radiation. In a case where application of varnish is employed, the second electrical insulation part 12 can be easily positioned as compared with a case where a film that is separately formed is disposed.

A first electrical insulation part 11, an electrical resistance part 10, and the second electrical insulation part 12 are fixed to the holder 140 by the heat shrinkable tube 30. By heating the heat shrinkable tube 30 in a state in which the first electrical insulation part 11, the electrical resistance part 10, the second electrical insulation part 12, and the heat shrinkable tube 30 are laminated in order on the holder 140, these structural elements can be easily fixed.

As described above, according to the present embodiment, the second electrical insulation part 12 can function as the heat radiation suppressor 20. This makes it unnecessary to separately dispose the heat radiation suppressor 20. It is therefore possible to increase productivity during manufacturing as compared with the first embodiment.

### 4. Third Embodiment

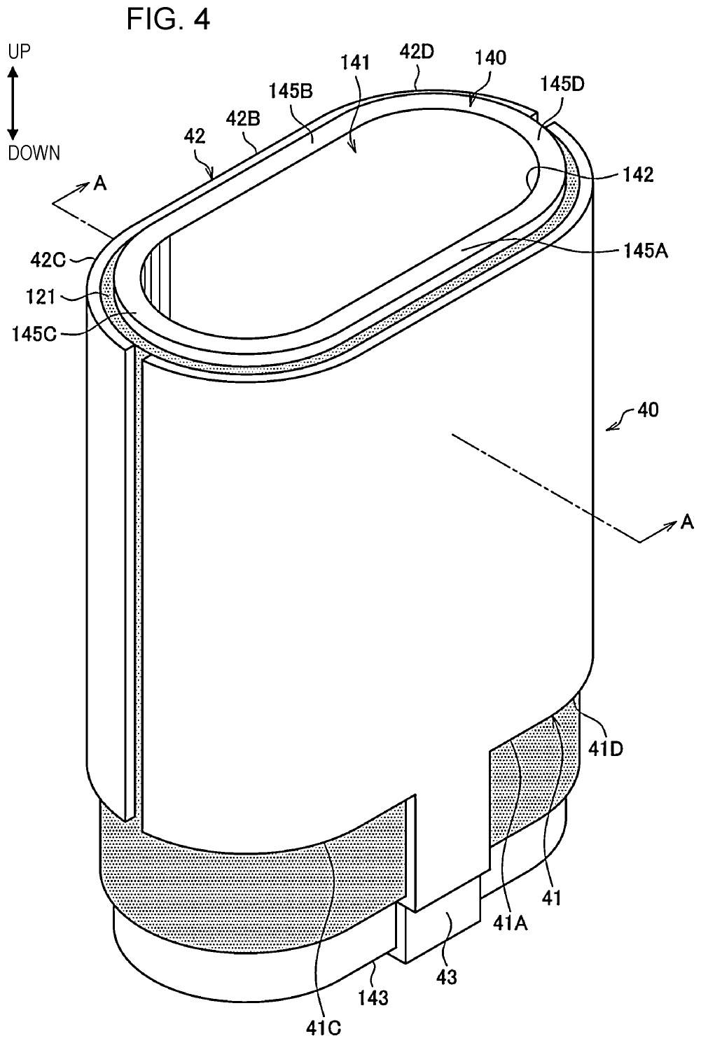

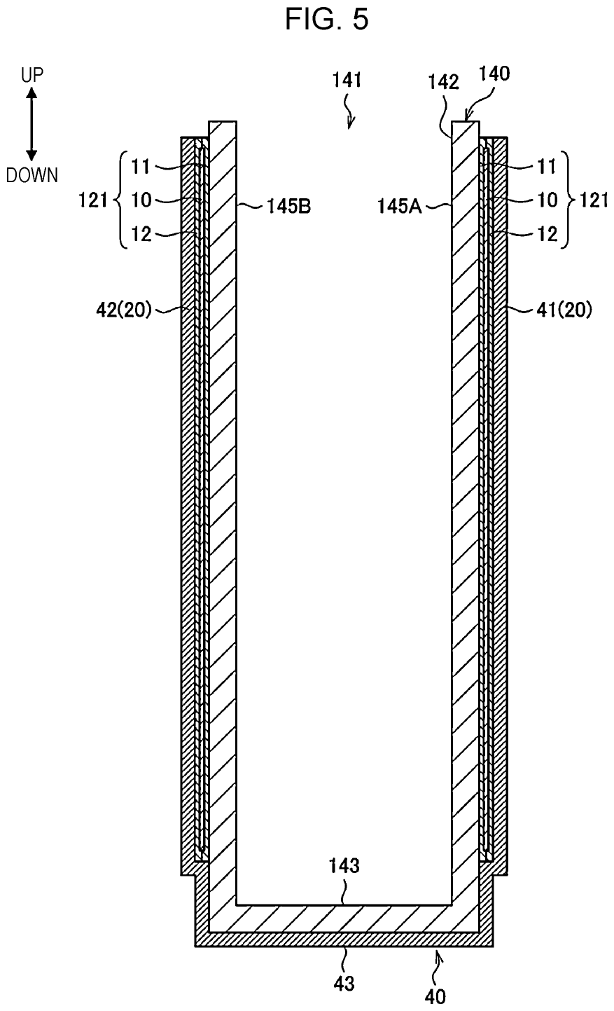

FIG. 4 is a perspective view of a configuration around a holder 140 of an inhaler device 100 according to the present embodiment. FIG. 5 is a cross-sectional view schematically illustrating a cross section around the holder 140 of the inhaler device 100 according to the present embodiment. FIG. 5 schematically illustrates a cross section taken along line A-A of FIG. 4. As illustrated in FIGS. 4 and 5, on a side surface of the holder 140, a heater 121 including a first electrical insulation part 11, an electrical resistance part 10, and a second electrical insulation part 12 is disposed, and a clip 40 is further disposed. A configuration of the heater 121 is similar to that in the first embodiment.

As illustrated in FIG. 4, the holder 140 according to the present embodiment is a tubular body whose cross-sectional shape is an obround shape. That is, the holder 140 has flat side walls 145A and 145B that face each other, curved side walls 145C and 145D that face each other, and a bottom 143. An inside diameter between the flat side wall 145A and the flat side wall 145B is shorter than an outside diameter of a columnar stick substrate 150. The holder 140 holds the stick substrate 150 while pressing the stick substrate 150 between the flat side wall 145A and the flat side wall 145B when the stick substrate 150 is inserted into an internal space 141. According to this configuration, it is possible to prevent the stick substrate 150 from coming off and improve heating efficiency of the stick substrate 150 in the pressed part.

As illustrated in FIG. 4, the clip 40 has a first panel 41, a second panel 42, and a coupling part 43. As illustrated in FIG. 5, the clip 40 holds the holder 140 between the first panel 41 and the second panel 42 from an outer side of the second electrical insulation part 12. The first panel 41 and the second panel 42 are planar members. The first panel 41 and the second panel 42 have rigidity and elasticity, and fit side walls of the holder 140 when the clip 40 holds the holder 140. The coupling part 43 is an elastic body that couples the first panel 41 and the second panel 42. The coupling part 43 exhibits elasticity in such a direction that brings the first panel 41 and the second panel 42 closer to each other. This can fix the heater 121 to the holder 140.

As illustrated in FIG. 4, the first panel 41 and the second panel 42 have a shape along a shape of the side walls of the holder 140. Specifically, the first panel 41 has a flat surface 41A along the flat side wall 145A of the holder 140 and curved surfaces 41C and 41D extending from both ends of the flat surface 41A so as to be curved along the curved side walls 145C and 145D of the holder 140. Similarly, the second panel 42 has a flat surface 42B along the flat side wall 145B of the holder 140 and curved surfaces 42C and 42D extending from both ends of the flat surface 42B so as to be curved along the curved side walls 145C and 145D of the holder 140. According to this configuration, the clip 40 can bring the holder 140, the heater 121, the first panel 41, and the second panel 42 into close contact with each other.

As illustrated in FIG. 4, the coupling part 43 couples the flat surface 41A of the first panel 41 and the flat surface 42B of the second panel 42. The clip 40 holds the holder 140 in a state where the flat surface 41A of the first panel 41 and the flat surface 42B of the second panel 42 are positioned to fit the flat side walls 145A and 145B of the holder 140. According to this configuration, the heater 121 can be brought into close contact with the flat side walls 145A and 145B against which the stick substrate 150 is pressed among the side walls of the holder 140. This makes it possible to further improve heating efficiency of the stick substrate 150.

The first panel 41 and the second panel 42 also function as the heat radiation suppressor that suppresses heat radiation. That is, at least a part of the first panel 41 and the second panel 42 is made of any material that has a property of suppressing heat radiation. For example, the first panel 41 and the second panel 42 may have a layer having rigidity and elasticity on an outer side and a layer that suppresses heat radiation on an inner side. According to this configuration, efficient heating of the stick substrate 150, improvement of stability of operation of the inhaler device 100, and improvement of user's safety can be achieved, as described in the first embodiment.

As described above, according to the present embodiment, heating efficiency of the stick substrate 150 can be improved by suppressing heat radiation to an outside while fixing the heater 121 to the holder 140 by the clip 40 that also functions as the heat radiation suppressor 20. In the present embodiment, a step of separately forming the heat radiation suppressor 20 or disposing the heat shrinkable tube 30 and applying heat is replaced with attachment of the clip 40, which is easier. It is therefore possible to increase productivity during manufacturing as compared with the first embodiment.

### 5. Fourth Embodiment

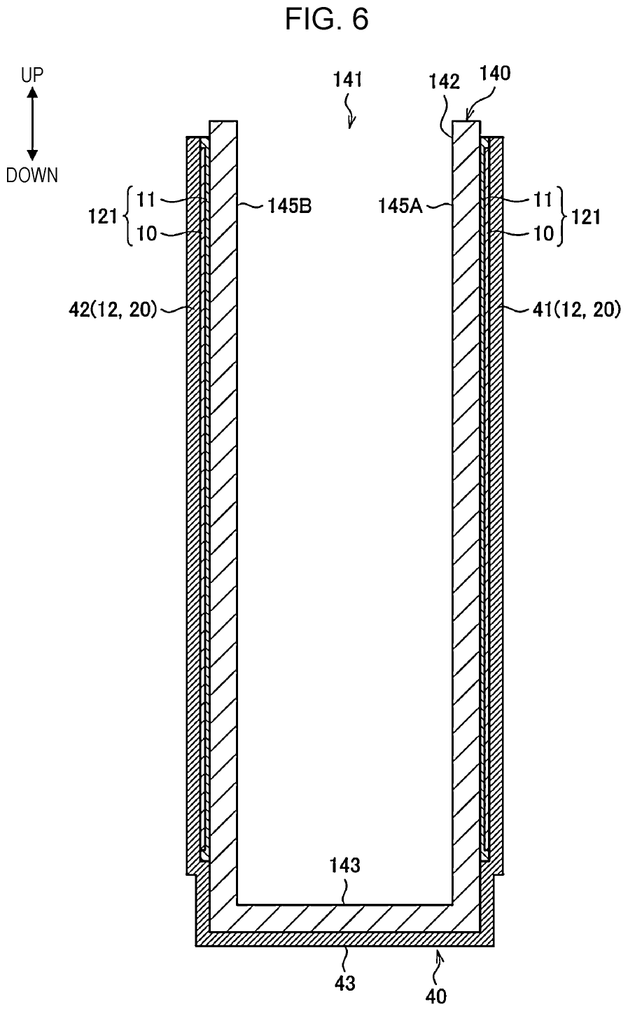

FIG. 6 is a cross-sectional view schematically illustrating a cross section around a holder 140 of an inhaler device 100 according to the present embodiment. In the inhaler device 100 according to the present embodiment, the holder 140 is held by a clip 40, as in the third embodiment.

As illustrated in FIG. 6, a heater 121 that includes a first electrical insulation part 11 and an electrical resistance part 10 and the clip 40 are disposed on a side surface of the holder 140. The inhaler device 100 according to the present embodiment is different from the third embodiment in that the heater 121 does not have a second electrical insulation part 12. The following mainly describes differences from the third embodiment, and description of points similar to those in the third embodiment is omitted.

A first panel 41 and a second panel 42 also function as the second electrical insulation part 12 having an electrical insulation property and a heat radiation suppressor 20 that suppresses heat radiation. That is, at least a part of the first panel 41 and the second panel 42 is made of any material having an electrical insulation property and any material having a property of suppressing heat radiation. For example, the first panel 41 and the second panel 42 may have a layer having rigidity and elasticity on an outer side and a layer having an electrical insulation property and a layer that suppresses heat radiation on an inner side. The clip 40 holds the holder 140 between the first panel 41 and the second panel 42 from an outer side of the electrical resistance part 10. According to this configuration, short-circuit of the electrical resistance part 10 can be prevented. Furthermore, efficient heating of the stick substrate 150, improvement of stability of operation of the inhaler device 100, and improvement of user's safety can be achieved, as in the third embodiment.

As described above, according to the present embodiment, the clip 40 can function not only as the heat radiation suppressor 20, but also as the second electrical insulation part 12. This makes it unnecessary to separately dispose the second electrical insulation part 12. It is therefore possible to increase productivity during manufacturing as compared with the third embodiment.

### 6. Additional Remarks

Although the preferred embodiments of the present invention have been described in detail above with reference to the attached drawings, the present invention is not limited to these examples. It is apparent that a person who has ordinary knowledge in the field of art to which the present invention pertains can arrive at various changes or modifications within the technical idea described in the claims, and it is understood that these changes or modifications are also encompassed within the technical scope of the present invention.

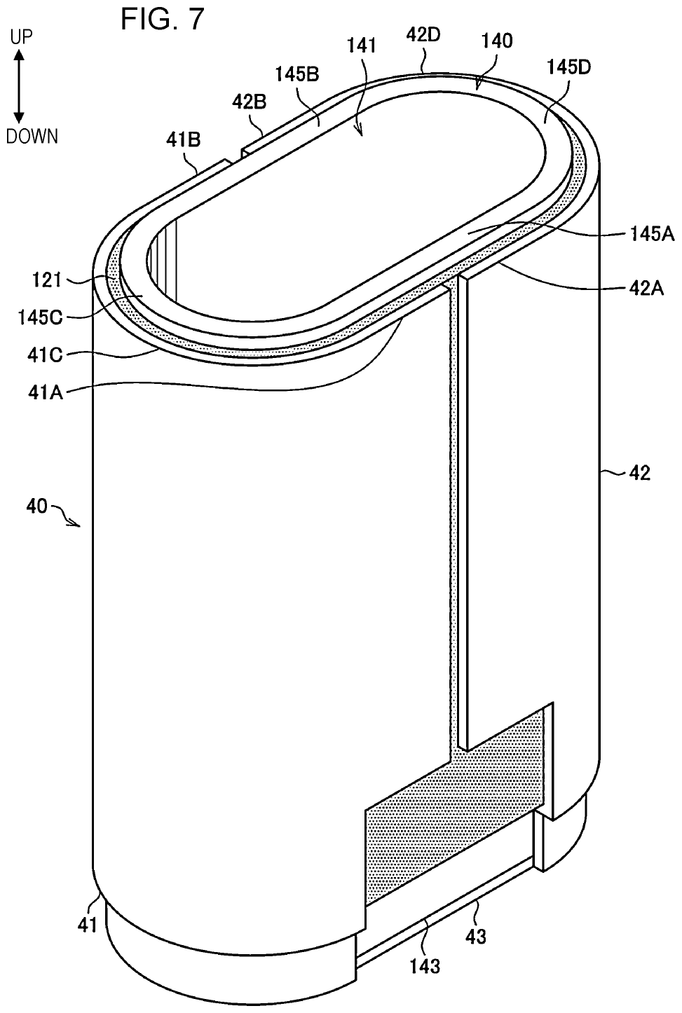

For example, although an example in which the clip 40 holds the flat side walls 145A and 145B of the holder 140 between the first panel 41 and the second panel 42 has been described in the above embodiments, the present invention is not limited to this example. Another example is described with reference to FIG. 7. FIG. 7 is a perspective view of a configuration around a holder 140 of an inhaler device 100 according to a modification. As illustrated in FIG. 7, a first panel 41 has a curved surface 41C curved along a curved side wall 145C of the holder 140 and flat surfaces 41A and 41B extending from both ends of the curved surface 41C along flat side walls 145A and 145B of the holder 140. Similarly, a second panel 42 has a curved surface 42D curved along a curved side wall 145D of the holder 140 and flat surfaces 42A and 42B extending from both ends of the curved surface 42D along the flat side walls 145A and 145B of the holder 140. A clip 40 holds the curved side walls 145C and 145D of the holder 140 between the first panel 41 and the second panel 42. That is, from which direction the holder 140 is held by the clip 40 is not limited in particular, as long as the first panel 41 and the second panel 42 have a shape along a shape of the side walls of the holder 140. In any case, the clip 40 can fix the heater 121 to the holder 140.

For example, although an example in which the holder 140 is a tubular body whose cross-sectional shape is an obround shape has been described in the above embodiments, the present invention is not limited to this example. The holder 140 may be a tubular body having a circular, elliptic, or polygonal cross-sectional shape.

For example, although description of a relationship between the heat radiation suppressor 20 and the heat insulator 144 is omitted in the above embodiments, the relationship may be designed freely. In an example, the heat insulator 144 may be disposed outside the heat radiation suppressor 20 or a structural element (e.g., the second electrical insulation part 12 or the clip 40) that functions as the heat radiation suppressor 20.

Note that the following configurations also belongs to the technical scope of the present invention.

(1)

An aerosol generation system that generates an aerosol by heating an aerosol generation article that contains an aerosol source, the aerosol generation system including:
a container that has an internal space and an opening that allows the internal space to communicate with an outside and accommodates the aerosol generation article inserted into the internal space through the opening;
a first electrical insulation part that is a film-shaped member having an electrical insulation property and is disposed outside the container;
an electrical resistance part that is disposed outside the first electrical insulation part and produces heat in a case where an electric current passes therethrough; and
a heat radiation suppressor that is disposed outside the electrical resistance part and suppresses heat radiation.
   (2)

The aerosol generation system according to (1), in which
the aerosol generation system includes, as the heat radiation suppressor, a second electrical insulation part that is a film-shaped member having an electrical insulation property that is disposed outside the electrical resistance part and suppresses heat radiation; and
the electrical resistance part is sandwiched between the first electrical insulation part and the second electrical insulation part.
   (3)

The aerosol generation system according to (2), in which
the second electrical insulation part is formed by applying varnish containing a material having an electrical insulation property and a material having a property of suppressing heat radiation.
   (4)

The aerosol generation system according to (1), further including a second electrical insulation part that is a film-shaped member having an electrical insulation property and is disposed outside the electrical resistance part,
in which
the electrical resistance part is sandwiched between the first electrical insulation part and the second electrical insulation part; and
the heat radiation suppressor is disposed outside the second electrical insulation part.
   (5)

The aerosol generation system according to (4), in which
the heat radiation suppressor is formed by applying varnish containing a material having a property of suppressing heat radiation.
   (6)

The aerosol generation system according to any one of (2) to (5), in which
the first electrical insulation part and the second electrical insulation part are made of one or more materials selected from the group consisting of polyimide, PEEK, polyurethane, epoxy, polyester, acrylic, phenol, and silicone as a material having an electrical insulation property.
   (7)

The aerosol generation system according to any one of (1) to (6), in which
the heat radiation suppressor is made of one or more materials selected from the group consisting of SiC, TiO₂, alumina, yttria, a metal oxide, and a composite metal containing a plurality of metal atoms and a plurality of oxygen atoms as a material that has a property of suppressing heat radiation.
   (8)

The aerosol generation system according to any one of (1) to (7), in which
the first electrical insulation part, the electrical resistance part, and the heat radiation suppressor are fixed to the container by a heat shrinkable tube.
   (9)

The aerosol generation system according to any one of (1) to (7), further including:
a second electrical insulation part that is a film-shaped member having an electrical insulation property that is disposed outside the electrical resistance part; and
a clip including a first panel that is the heat radiation suppressor configured as a planar member, a second panel that is the heat radiation suppressor configured as a planar member, and a coupling part that is an elastic body that couples the first panel and the second panel,
in which
the clip holds the container between the first panel and the second panel from an outer side of the second electrical insulation part.
   (10)

The aerosol generation system according to any one of (1) to (7), further including a clip including a first panel that is the heat radiation suppressor configured as a planar member and has an electrical insulation property, a second panel that is the heat radiation suppressor configured as a planar member and has an electrical insulation property, and a coupling part that is an elastic body that couples the first panel and the second panel,
in which
the clip holds the container between the first panel and the second panel from an outer side of the electrical resistance part.
   (11)

The aerosol generation system according to (9) or (10), in which
the first panel and the second panel have a shape along a shape of a side wall of the container.
   (12)

The aerosol generation system according to any one of (9) to (11), in which the container has two flat side walls that face each other;
the first panel and the second panel each have a flat surface;
the coupling part couples the flat surface of the first panel and the flat surface of the second panel; and
the clip holds the container in a state where the flat surface of the first panel and the flat surface of the second panel are positioned to fit the two flat side walls of the container.
   (13)

The aerosol generation system according to any one of (1) to (12), further including the aerosol generation article.

### REFERENCE SIGNS LIST

100 inhaler device
111 power supply
112 sensor
113 notifier
114 memory
115 communicator
116 controller
121 heater
140 holder
141 internal space
142 opening
143 bottom
144 heat insulator
145 side wall (145A, 145B: flat side wall 145C, 145D: curved side wall)
150 stick substrate
151 substrate
152 inhalation port
10 electrical resistance part
11 first electrical insulation part
12 second electrical insulation part
20 heat radiation suppressor
30 heat shrinkable tube
40 clip
41 first panel (41A, 41B: flat surface 41C, 41D: curved surface)
42 second panel (42A, 42B: flat surface 42C, 42D: curved surface)
43 coupling part

1. An aerosol generation system that generates an aerosol by heating an aerosol generation article that contains an aerosol source, the aerosol generation system comprising:
a container that has an internal space and an opening that allows the internal space to communicate with an outside and accommodates the aerosol generation article inserted into the internal space through the opening;
a first electrical insulation part that is a film-shaped member having an electrical insulation property and is disposed outside the container;
an electrical resistance part that is disposed outside the first electrical insulation part and produces heat in a case where an electric current passes therethrough; and
a heat radiation suppressor that is disposed outside the electrical resistance part and suppresses heat radiation.

2. The aerosol generation system according to claim 1, wherein
the aerosol generation system comprises, as the heat radiation suppressor, a second electrical insulation part that is a film-shaped member having an electrical insulation property that is disposed outside the electrical resistance part and suppresses heat radiation; and
the electrical resistance part is sandwiched between the first electrical insulation part and the second electrical insulation part.

3. The aerosol generation system according to claim 2, wherein
the second electrical insulation part is formed by applying varnish containing a material having an electrical insulation property and a material having a property of suppressing heat radiation.

4. The aerosol generation system according to claim 1, further comprising a second electrical insulation part that is a film-shaped member having an electrical insulation property and is disposed outside the electrical resistance part,
wherein
the electrical resistance part is sandwiched between the first electrical insulation part and the second electrical insulation part; and
the heat radiation suppressor is disposed outside the second electrical insulation part.

5. The aerosol generation system according to claim 4, wherein
the heat radiation suppressor is formed by applying varnish containing a material having a property of suppressing heat radiation.

6. The aerosol generation system according to claim 2, wherein
the first electrical insulation part and the second electrical insulation part are made of one or more materials selected from the group consisting of polyimide, PEEK, polyurethane, epoxy, polyester, acrylic, phenol, and silicone as a material having an electrical insulation property.

7. The aerosol generation system according to claim 1, wherein
the heat radiation suppressor is made of one or more materials selected from the group consisting of SiC, TiO₂, alumina, yttria, a metal oxide, and a composite metal containing a plurality of metal atoms and a plurality of oxygen atoms as a material that has a property of suppressing heat radiation.

8. The aerosol generation system according to claim 1, wherein
the first electrical insulation part, the electrical resistance part, and the heat radiation suppressor are fixed to the container by a heat shrinkable tube.

9. The aerosol generation system according to claim 1, further comprising:
a second electrical insulation part that is a film-shaped member having an electrical insulation property that is disposed outside the electrical resistance part; and
a clip including a first panel that is the heat radiation suppressor configured as a planar member, a second panel that is the heat radiation suppressor configured as a planar member, and a coupling part that is an elastic body that couples the first panel and the second panel,
wherein
the clip holds the container between the first panel and the second panel from an outer side of the second electrical insulation part.

10. The aerosol generation system according to claim 1, further comprising a clip including a first panel that is the heat radiation suppressor configured as a planar member and has an electrical insulation property, a second panel that is the heat radiation suppressor configured as a planar member and has an electrical insulation property, and a coupling part that is an elastic body that couples the first panel and the second panel,
wherein
the clip holds the container between the first panel and the second panel from an outer side of the electrical resistance part.

11. The aerosol generation system according to claim 9, wherein
the first panel and the second panel have a shape along a shape of a side wall of the container.

12. The aerosol generation system according to claim 9, wherein
the container has two flat side walls that face each other;
the first panel and the second panel each have a flat surface;
the coupling part couples the flat surface of the first panel and the flat surface of the second panel; and
the clip holds the container in a state where the flat surface of the first panel and the flat surface of the second panel are positioned to fit the two flat side walls of the container.

13. The aerosol generation system according to claim 1, further comprising the aerosol generation article.
